(19) United States
(12) Patent Application Publication
(10) Pub. No.: US 2006/0010366 A1
(43) Pub. Date: Jan. 12, 2006

(54) Multimedia content generator

(76) Inventors: Takako Hashimoto, Tokyo (JP); Christophe Soulier, Chiba (JP); Nozomu Takahashi, Tokyo (JP); Takayuki Kunieda, Tokyo (JP)

Correspondence Address: DICKSTEIN SHAPIRO MORIN & OSHINSKY LLP, 2101 L Street, NW, Washington, DC, 20037, US

(21) Appl. No.: 11/119,796

(22) Filed: May 3, 2005

(30) Foreign Application Priority Data
May 18, 2004 (JP) 2004-147847

(51) Int. Cl. G06F 15/00; G06F 17/30; G06F 17/00

(52) U.S. Cl. 715/500.1; 715/745; 707/3

(57) ABSTRACT

A multimedia content generator automatically generates a commercial content (for example, a preview of a movie) from an original content (i.e. the movie). The multimedia content generator includes a use purpose setting unit, a use environment setting unit, and a content generator. The content editor generates the commercial content according to: use purpose of the commercial content set by the use purpose setting unit; and use environment (such as a terminal which reproduces the commercial content) set by the use environment setting unit.

### CROSS-REFERENCE TO RELATED APPLICATIONS

The present document incorporates by reference the entire contents of Japanese priority document, 2004-147847 filed in Japan on May 18, 2004.

### BACKGROUND OF THE INVENTION

1) Field of the Invention

The present invention relates to a technique for automatically generating multimedia contents.

2) Description of the Related Art

Recently, so-called “commercial content” (hereinafter, “CM content”) is generally provided for enabling users to select a desired content from among a plurality of multimedia contents (hereinafter, “MM content”). The CM content can be a digest of the MM content, or a commercial preview thereof which has more advertising effect than the digest.

However, it is too expensive to manually generate the CM content for each of the MM content. A technique for automatically generating a digest of a content according to each user's preference has been suggested (see, for example, Japanese Patent Application Laid-Open No. 2003-333500). However, the above technique does not take into consideration the use purpose of the digest (such as commercial purpose) or to the use environment in which the digest is reproduced (such as a terminal).

### SUMMARY OF THE INVENTION

It is an object of the present invention to at least solve the problems in the conventional technology.

A multimedia content generator according to an aspect of the present invention generates a multimedia content from a plurality of materials extracted from an original content. The multimedia content generator includes: a use purpose setting unit that sets use purpose of the multimedia content; a use environment setting unit that sets use environment in which the multimedia content is reproduced; and a content generator that generates the multimedia content based on the use purpose and the used environment.

A method according to another aspect of the present invention is a method for generating a multimedia content from a plurality of materials extracted from an original content. The method includes: setting use purpose of the multimedia content and use environment in which the multimedia content is reproduced; and generating the multimedia content based on the use purpose and the used environment.

A computer-readable recording medium according to still another aspect of the present invention stores a computer program that causes a computer to execute the above method.

The other objects, features, and advantages of the present invention are specifically set forth in or will become apparent from the following detailed description of the invention when read in conjunction with the accompanying drawings.

### BRIEF DESCRIPTION OF THE DRAWINGS

FIG. 1 is a functional block diagram of an MM content generator according to a first embodiment of the present invention;

FIG. 2 is a diagram for explaining importance of each component of original contents;

FIG. 3 is a flowchart of procedures performed by the MM content generator;

FIGS. 4 and 5 are diagrams of a CM template;

FIG. 6 is a diagram of an MM content generated by the MM content generator;

FIG. 7 is a functional block diagram of an MM content generator according to a second embodiment of the present invention;

FIG. 8 is a functional block diagram of an MM content generator according to a third embodiment of the present invention; and

FIG. 9 is a block diagram for explaining a hardware configuration of the MM content generator.

### DETAILED DESCRIPTION

Exemplary embodiments of the present invention will be explained below in detail with reference to the accompanying drawings.

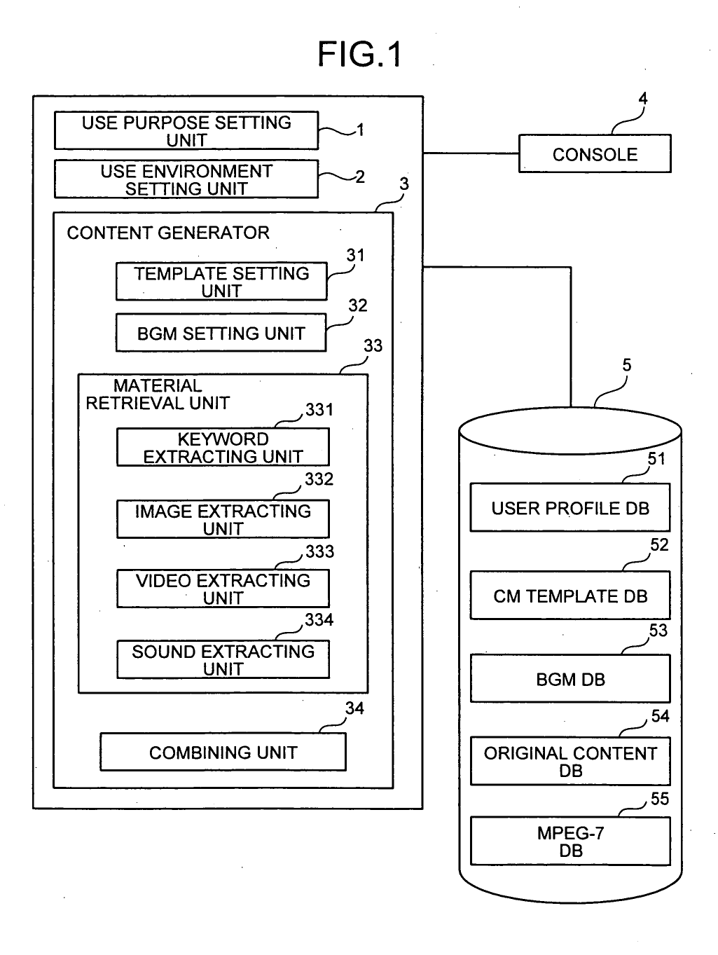

FIG. 1 is a functional block diagram of an MM content generator according to a first embodiment of the present invention. The MM content generator includes a use purpose setting unit 1, a use environment setting unit 2, a content generator 3, a console 4, and a storage unit 5.

The use purpose setting unit 1 holds use purpose information, which is input from the user through the console 4 or read out from the storage unit 5. The use purpose information indicates use purpose of the MM content generated by the MM content generator, such as “CM content” and “educational content”. In the following explanation, it is assumed that the use purpose information is set with “CM content”.

The use environment setting unit 2 holds use environment information, which is input from the user through the console 4 or read out from the storage unit 5. The use environment information indicates use environment in which the MM content is reproduced, such as “mobile terminal”, “TV terminal”, and “personal computer (PC)”.

The content generator 3 generates the MM content, such as a preview of a movie, a product presentation, and a promotion video by editing original content stored in the storage unit 5 according to the use purpose information and the use environment information. The content generator 3 includes a template setting unit 31, a background music (BGM) setting unit 32, a material retrieval unit 33, and a combining unit 34.

The console 4 includes an input device (such as a keyboard and a mouse) and a display (such as a liquid crystal display) for enabling the user to input the use purpose information and the environment information, and to reproduce the MM content.

The storage unit 5 includes a user profile database (DB) 51, a CM template DB 52, a BGM DB 53, an original content DB 54, and an MPEG-7 DB 55. The user profile DB 51 stores various kind of information on the user, which can include the use purpose information and the use environment information. The CM template DB 52 stores a CM template, which designates various parameters such as screen layout, timeline of each original content, and switching effects, of the MM content to be generated. The BGM DB 53 stores sound data of music, which is normally copyright-free music. The original content DB 54 stores MM contents to be edited by the content generator 3. The MPEG-7 DB 55 stores an index of the original contents stored in the original content DB 54. The original contents can be obtained through digital broadcast, downloaded from a website, or generated by MPMeister® of Ricoh® Corp, which automatically generates Web content from a presentation file created by PowerPoint®.

Each functional unit of the content generator 3 will be explained next. The template setting unit 31 selects a CM template for generating the MM content from the CM templates stored in the CM template DB 52. The template setting unit 31 selects the CM template according to the user's instruction, or according to the use purpose and the use environment information.

Furthermore, the template setting unit 31 creates a new CM template according to parameters input from the user through the console 4, or by combining parts of existing CM templates according to the use purpose information and the use environment information.

Furthermore, the template setting unit 31 displays a variety of CM templates on the console 4, enabling the user to select a template which suits the taste of the user or the MM content to be generated.

The BGM setting unit 32 sets BGM of the MM content to be generated. The BGM setting unit 32 selects one of the sound data stored in the BGM DB 53 according to the user's instruction, or according to the user's preference stored in the user profile DB 51.

The material retrieval unit 33 accesses the original content DB 54, and retrieves the original contents required to generate the MM content. The material retrieval unit 33 includes a keyword extracting unit 331, an image extracting unit 332, a video extracting unit 333, and a sound extracting unit 334.

The keyword extracting unit 331 extracts keywords from the original content DB 54 and the MPEG-7 DB 55 by an existing keyword extraction technique, and sets the importance of each keyword. The user can edit the extracted keyword, change the importance thereof, add a new keyword and set the importance thereof, through the keyword extracting unit 331.

The image extracting unit 332 calculates the importance of each image in the original contents using a conventional technique and the keywords, and extracts important images (images having high importance) from the original contents. The importance is, for example, high in such an image including any one of the keywords as its metadata. The user can manually change the importance of each image, select a specific image and set the importance thereof, through the image extracting unit 332.

The video extracting unit 333 calculates the importance of each scene in the original contents using a conventional technique for analyzing camera movement (such as zooms and scene changes) and the keywords, and extracts important scenes (scenes having high importance) from the original contents. The user can manually change the importance of each scene, select a specific scene and set the importance thereof, through the video extracting unit 333.

The sound extracting unit 334 calculates the importance of each sound in the original contents using a conventional technique and the keywords, and extracts important sounds (sounds having high importance) from the original contents. The importance is, for example, high in such a sound including different speakers' utterances or any one of the keywords, and low in the sound not including the keywords. The user can manually change the importance of each sound, select a specific sound and set the importance thereof, through the sound extracting unit 334.

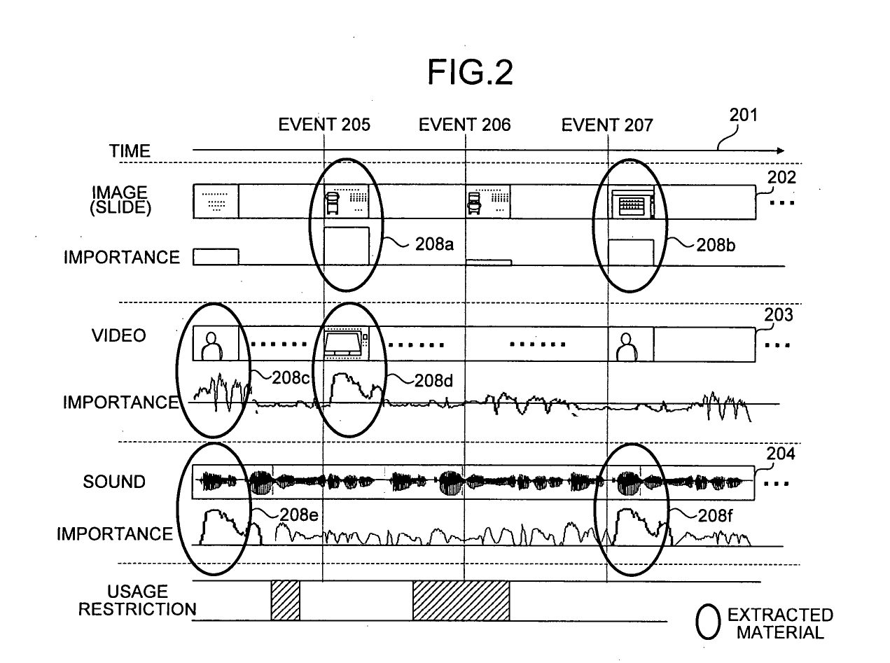

FIG. 2 is a diagram for explaining the importance of each component of the original contents. An image 202, a video 203, and a sound 204, which are aligned along a time axis 201, are the original contents. Events 205, 206, and 207 are metadata which are attached to the original contents and indicate, for example, the timing of each slide change in the presentation of PPT file (file created by PowerPoint®).

The combining unit 34 shown in FIG. 1 combines, according to the use purpose information and the use environment information, the CM template selected by the template setting unit 31, the BGM selected by the BGM setting unit 32, and materials extracted by the material retrieval unit 33 (such as images (slides) 208a and 208b, videos (scenes) 208c and 208d, and sounds 208e and 208f shown in FIG. 2), to generate the MM content. Relevance between the extracted materials need not be taken into consideration because in many cases, each component of a CM content need not be closely related to each other. However, of course, it is also possible to calculate the relevance and extract the material based on the importance and the relevance.

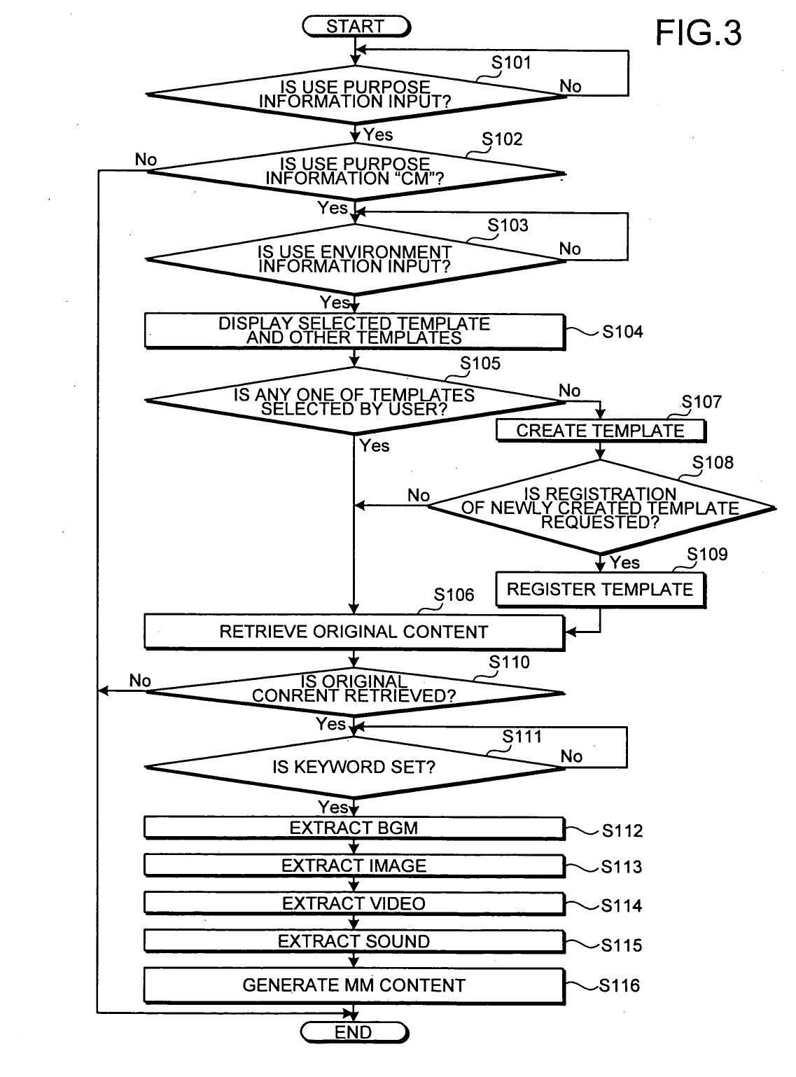

FIG. 3 is a flowchart of procedures performed by the MM content generator. The use purpose setting unit 1 receives the use purpose information input from the user through the console 4 (step S101: Yes). When the use purpose information is “CM content” (step S102: Yes), the use environment setting unit 2 receives the use environment information input from the user through the console 4 (step S103: Yes). The template setting unit 31 of the content generator 3 selects one of the CM templates stored in the CM template DB 52, based on the use purpose information and the use environment information, and displays the selected CM template and other CM templates on the console 4 (step S104).

When the user selects any one of the CM templates on the console 4 within a predetermined period of time (step S105: Yes), the material retrieval unit 33 retrieves the original content according to the selected CM template (step S106).

On the other hand, when the user does not select any CM template (step S105: No), the template setting unit 31 creates a new template according to parameters input from the user (step S107), and registers the template in the CM template DB 52 when the user requested (step S108: Yes, step S109). Then, the material retrieval unit 33 retrieves the original content according to the newly created template (step S106).

When the original content is retrieved within a predetermined period of time (step S110: Yes), the keyword extracting unit 331 determines whether a keyword has been set (step S111). The keyword can be set manually by the user, or set automatically according to the use purpose information and the use environment information read out from the user profile DB 51.

After the keyword is set (step S111: Yes), the BGM setting unit 32 selects the BGM based on the keyword (step S112). Then the image extracting unit 332 calculates, using the keyword, the importance of each image included in the original content and extracts important images (step S113). Similarly, the video extracting unit 333 calculates, using the keyword, the importance of each scene included in the original content and extracts important scenes (step S114). The sound extracting unit 334 calculates, using the keyword, the importance of each sound included in the original content and extracts important sounds (step S115).

The combining unit 34 combines the selected BGM and the extracted materials such as image, video, and sound, according to the CM template selected based on the use purpose information and the use environment information, to generate the MM content (step S116).

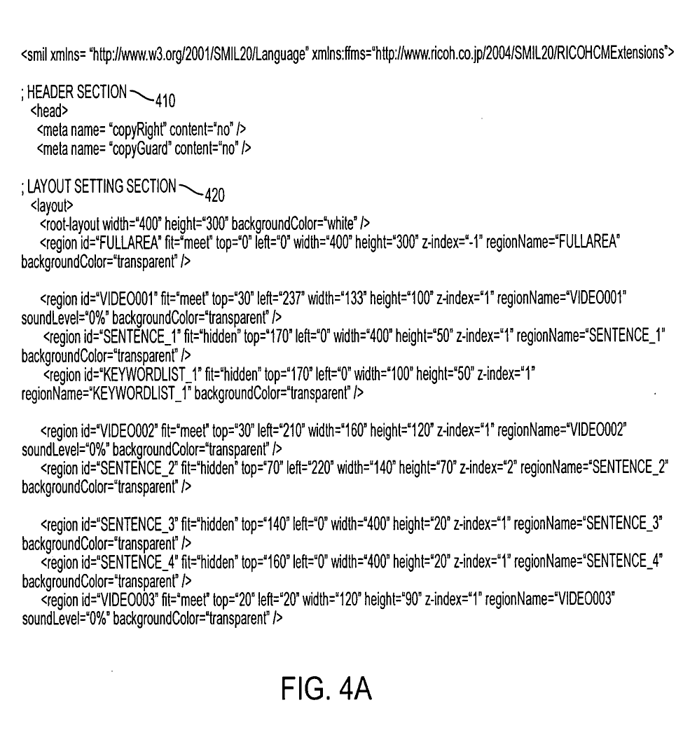

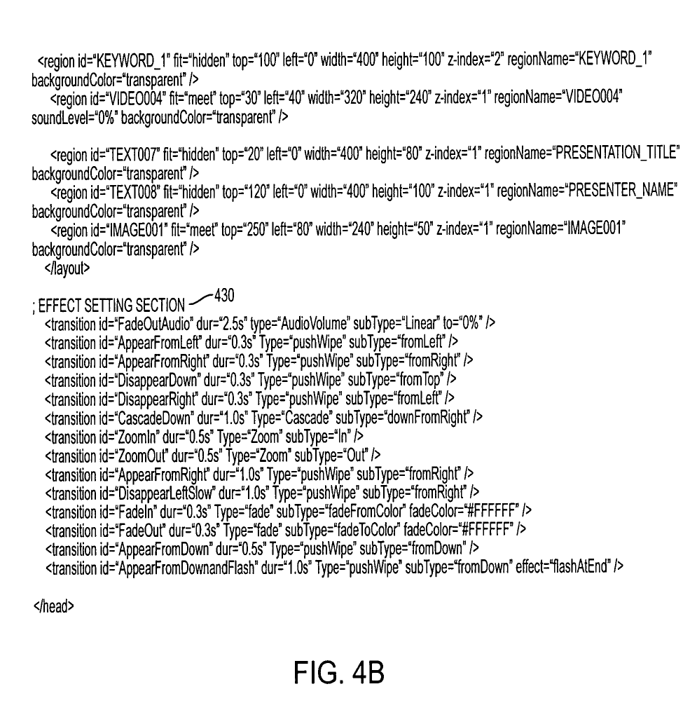

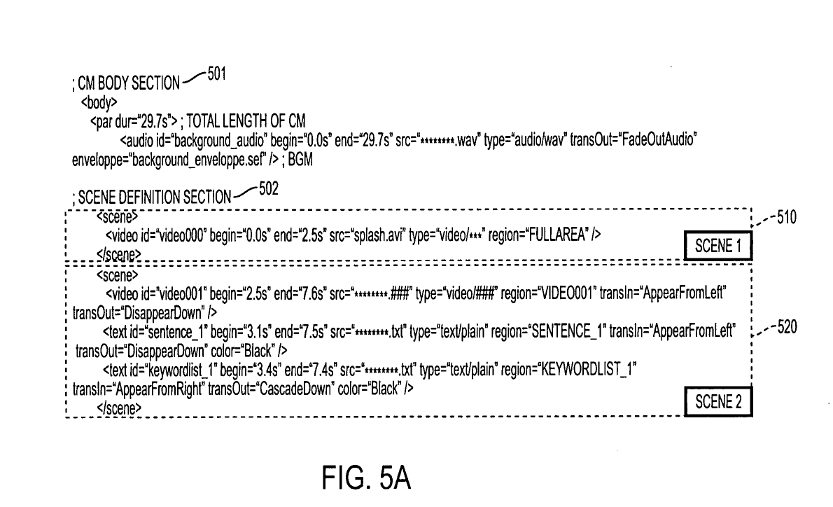

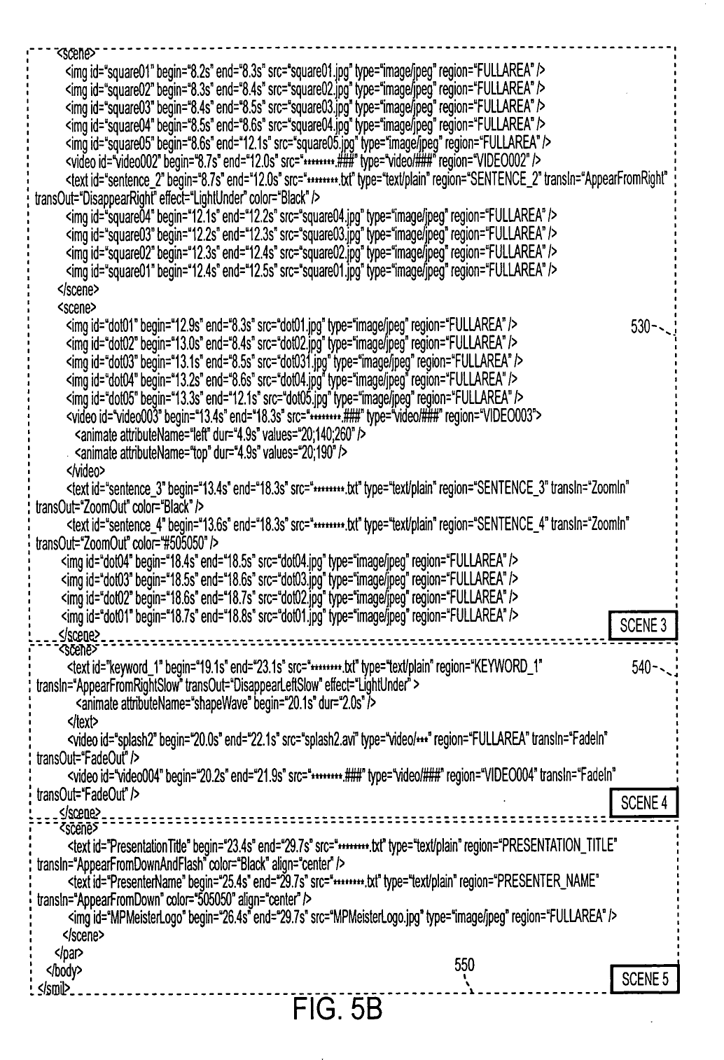

FIGS. 4 and 5 are diagrams of a CM template. A header section 410 shown in FIG. 4 includes copyright information. A layout setting section 420 includes layout information on each region of a window in which the MM content is displayed (such as identifier of each region, location of each region, size of each region, and order in which the regions are displayed). A effect setting section 430 includes switching effect information (such as fade-in/out and zoom-in/out).

A CM body section 501 shown in FIG. 5 defines the total length of the MM content and the BGM thereof. A scene definition section 502 includes a plurality of scene definitions 510, 520, 530, 540, and 550, which respectively defines configuration of scenes 1, 2, 3, 4, and 5 of the MM content. In FIG. 5, the begin time and the end time of each scene indicate the times measured from the start time of the content. However, the start time of each scene can be all 0 while the end time each scene indicates the time from the start time of the scene.

The sections shown in FIGS. 4 and 5 can be included in a single file, or different files.

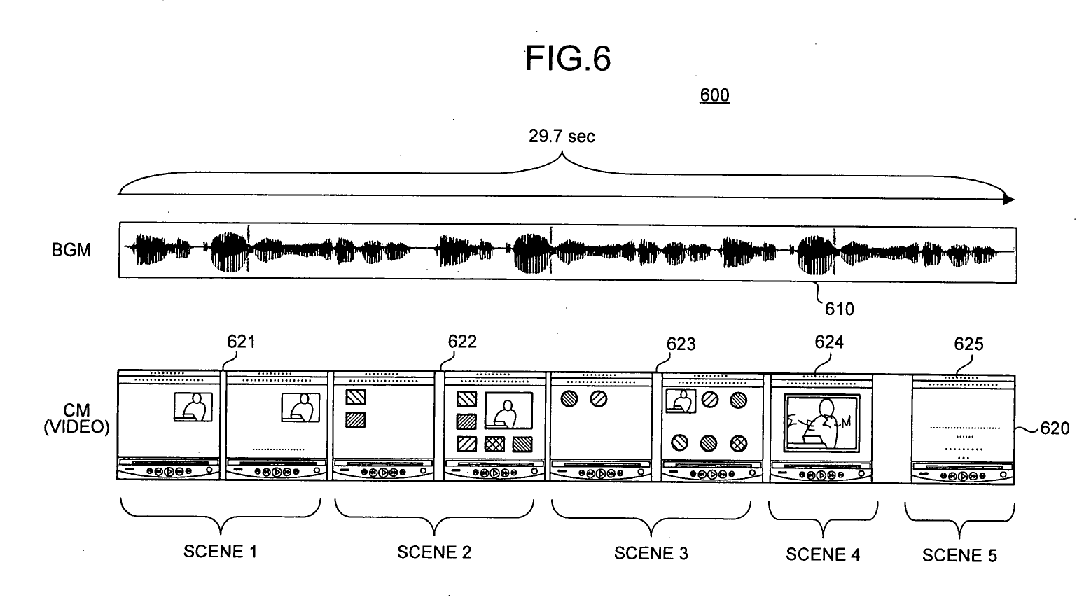

FIG. 6 is a diagram of the MM content generated by the MM content generator. A CM content 600 includes a BGM 610 specified in the CM body section 501, and a video 620 including scenes 621, 622, 623, 624, and 625, which are respectively generated based on the scene definitions 510, 520, 530, 540, and 550 and laid-out based on the layout information in the layout setting section 420.

As explained above, the MM content generator according to the first embodiment can generate the CM content by combining original contents as prescribed in the CM template, which is automatically selected based on the use purpose and the use environment.

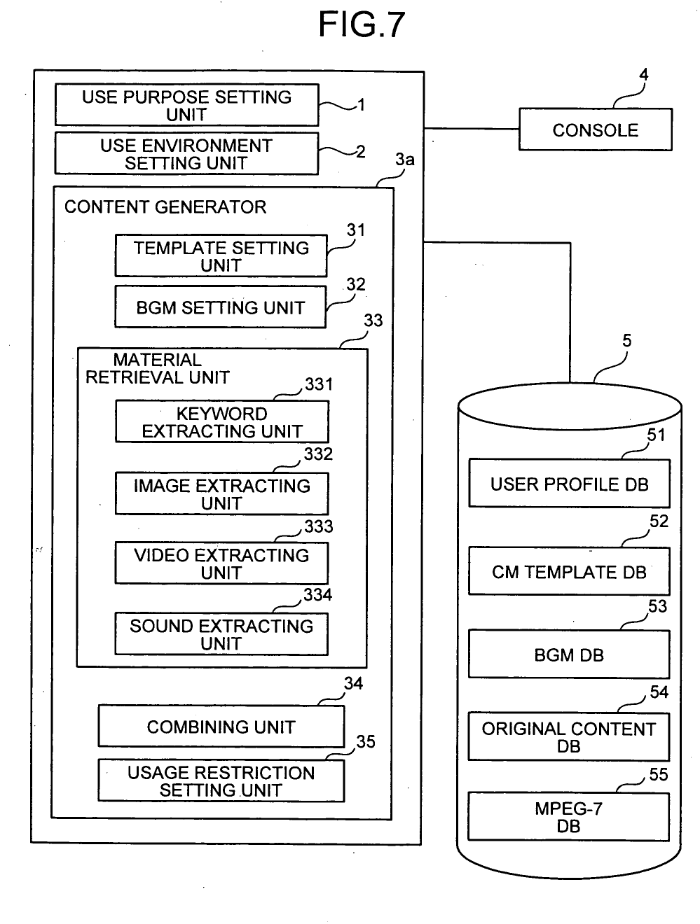

FIG. 7 is a functional block diagram of an MM content generator according to a second embodiment of the present invention. The MM content generator differs from that of the first embodiment in that it includes a usage restriction setting unit 35 in a content generator 3a. The usage restriction setting unit 35 sets usage restriction to prevent the content generator 3a from incorporating a specific part of the original content into the MM content. In other words, the MM content generator according to the second embodiment can generate the MM content which does not include any part designated not to be included in the MM content.

The usage restriction setting unit 35 receives, for example, a keyword input from the user through the console 4, and sets the keyword as the usage restriction. Alternatively, the usage restriction setting unit 35 can read out a pre-stored keyword from the user profile DB 51. The usage restriction setting unit 35 sets the usage restriction, for example, immediately before step S106 shown in FIG. 3. The content generator 3a does not extract materials including the keyword, or at least does not incorporate the extracted materials including the keyword into the MM content.

As explained above, the MM content generator according to the second embodiment can generate the MM content without offensive or antisocial content, thereby ensuring the MM content to be socially and morally acceptable.

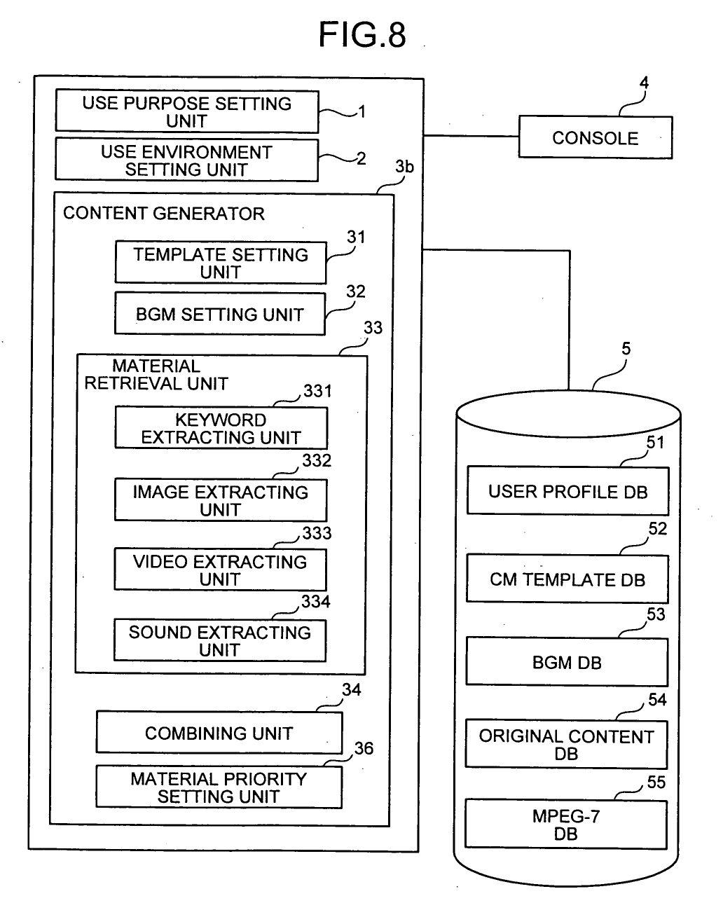

FIG. 8 is a functional block diagram of an MM content generator according to a third embodiment of the present invention. The MM content generator differs from that of the first embodiment in that it includes a material priority setting unit 36 in a content generator 3b. The material priority setting unit 36 sets material priority to increase the importance calculated by the respective extracting units. Thus, the MM content generator according to the third embodiment can extract the materials selectively from a part important for the user.

The material priority setting unit 36 receives material priority for each category of materials input from the user through the console 4. Alternatively, the material priority setting unit 36 can read out a pre-stored material priority from the user profile DB 51. The material priority setting unit 36 sets the material priority, for example, immediately before step S116 shown in FIG. 3. The content generator 3b generates, for example, a CM content including more video than image and sound, when the material priority of video is higher than those of image and sound.

As explained above, the MM content generator according to the third embodiment can generate the MM content selectively including materials of a specific category, in other words, the MM content fitting the user's preferences more accurately.

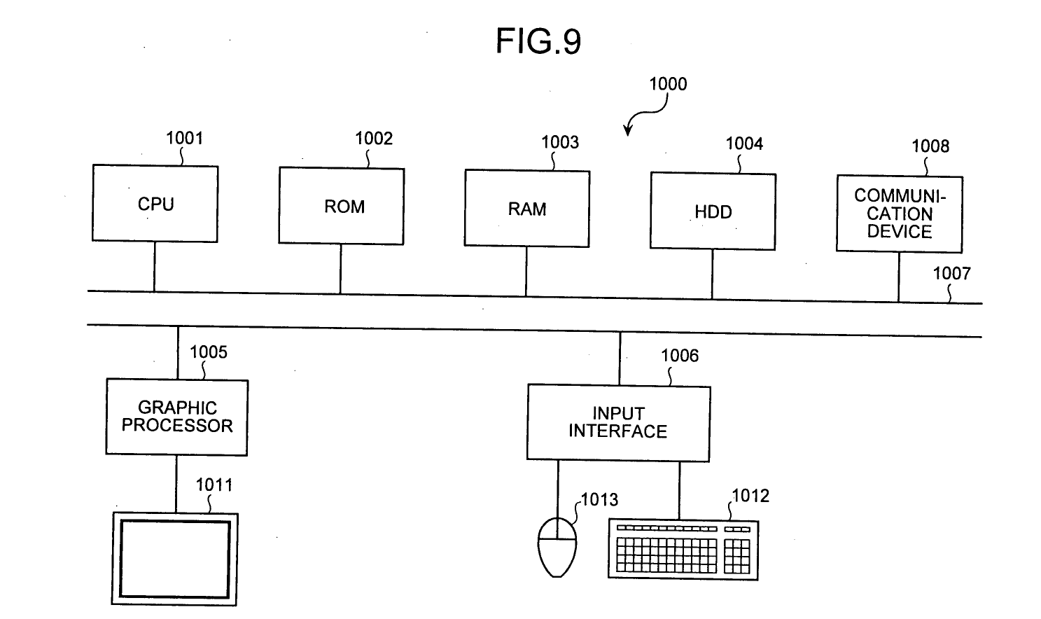

FIG. 9 is a block diagram for explaining a hardware configuration of the MM content generator according to the present invention. The MM content generator is a conventional personal computer, and includes a control device such as a central processing unit (CPU) 1001, storage devices such as a read-only memory (ROM) 1002 and a random access memory (RAM) 1003, external storage devices such as a hard disk drive (HDD) 1004 and a compact disk (CD) drive, display devices such as a graphic processor 1005 and a display 1011, and input devices such as an input interface 1006, a keyboard 1012, and a mouse 1013, and a communication device 1008.

A computer program executed by the MM content generator includes a plurality of modules which respectively correspond to the functional units described above. The computer program is recorded in the HDD 1004 and read out to the RAM 1003 by the CPU 1001 which executes the program.

The computer program can be recorded onto a computer-readable recording medium, such as the ROM 1002, a flexible disk (FD), a compact disc read only memory (CD-ROM), a compact disc recordable (CD-R), a digital versatile disk (DVD). Alternatively, the computer program can be distributed via a network such as the Internet.

Although the invention has been described with respect to a specific embodiment for a complete and clear disclosure, the appended claims are not to be thus limited but are to be construed as embodying all modifications and alternative constructions that may occur to one skilled in the art which fairly fall within the basic teaching herein set forth.

What is claimed is:

1. A multimedia content generator that generates a multimedia content from a plurality of materials extracted from an original content, comprising:
a use purpose setting unit that sets use purpose of the multimedia content;
a use environment setting unit that sets use environment in which the multimedia content is reproduced; and
a content generator that generates the multimedia content based on the use purpose and the used environment.

2. The multimedia content generator according to claim 1, wherein the multimedia content is a commercial content.

3. The multimedia content generator according to claim 2, wherein the commercial content is any one of a preview of a movie, a product presentation, and a promotion video.

4. The multimedia content generator according to claim 1, further comprising a user profile database that stores information on each user including information on the use purpose and information on the use environment information, wherein
the use purpose setting unit sets the use purpose according to the information stored in the user profile database, and
the use environment setting unit sets the use environment according to the information stored in the user profile database.

5. The multimedia content generator according to claim 1, wherein the content generator includes:
a template setting unit that selects a template for generating the multimedia content based on the use purpose and the use environment;
a music setting unit that selects a music specified in the template;
a material retrieval unit that retrieves the materials from the original content specified in the template; and
a combining unit that combines the selected music and the retrieved materials.

6. The multimedia content generator according to claim 5, further comprising a template database that stores a plurality of templates, wherein
the template setting unit selects one of the templates stored in the template database based on the use purpose and the use environment.

7. The multimedia content generator according to claim 6, wherein the template setting unit creates a new template according to a user's instruction and stores the new template in the template database.

8. The multimedia content generator according to claim 5, further comprising a music database that stores a plurality of music, wherein
the music setting unit selects one of the music specified in the template.

9. The multimedia content generator according to claim 5, wherein the music setting unit selects a background music of the multimedia content.

10. The multimedia content generator according to claim 5, further comprising an original content database that stores a plurality of original contents, wherein
the material retrieval unit retrieves the materials from the original content specified in the template and stored in the original content database.

11. The multimedia content generator according to claim 5, wherein the material retrieval unit includes:
a keyword extracting unit that extracts keyword from the original content;
an image extracting unit that extracts image from the original content;
a video extracting unit that extracts video from the original content; and
a sound extracting unit that extracts sound from the original content.

12. The multimedia content generator according to claim 11, wherein the keyword extracting unit calculates importance of each keyword included in the original content and extracts the keyword based the importance.

13. The multimedia content generator according to claim 11, wherein the image extracting unit calculates importance of each image included in the original content and extracts the image based on the importance.

14. The multimedia content generator according to claim 11, wherein the video extracting unit calculates importance of each scene included in the original content and extracts the scene as the video based on the importance.

15. The multimedia content generator according to claim 11, wherein the sound extracting unit calculates importance of each sound included in the original content and extracts the sound based on the importance.

16. The multimedia content generator according to claim 1, further comprising a restriction setting unit that designates a part of the materials not to be included in the multimedia content.

17. The multimedia content generator according to claim 1, further comprising a priority setting unit that sets, for each category of materials, a priority at which the materials are included in the multimedia content.

18. A method for generating a multimedia content from a plurality of materials extracted from an original content, comprising:
setting use purpose of the multimedia content and use environment in which the multimedia content is reproduced; and
generating the multimedia content based on the use purpose and the used environment.

19. The method according to claim 18, wherein the multimedia content is a commercial content.

20. The method according to claim 18, wherein the setting includes:
setting the use purpose according to use purpose information stored in a user profile database; and
setting the user environment according to use environment information stored in the user profile database.

21. A computer-readable recording medium that stores a computer program for generating a multimedia content from a plurality of materials extracted from an original content, wherein the computer program causes a computer to execute:
setting use purpose of the multimedia content and use environment in which the multimedia content is reproduced; and
generating the multimedia content based on the use purpose and the used environment.
